(19) United States
(12) Patent Application Publication
(10) Pub. No.: US 2002/0023098 A1
(43) Pub. Date: Feb. 21, 2002

(54) Web site system, center site, service site, and searching method

(76) Inventors: Hiroshi Ikeda, Kawasaki (JP); Hisayuki Tsubone, Kawasaki (JP); Yuji Kawada, Kawasaki (JP)

Correspondence Address: STAAS & HALSEY LLP, 700 11TH STREET, NW, SUITE 500, WASHINGTON, DC, 20001, US

(21) Appl. No.: 09/882,178

(22) Filed: Jun. 18, 2001

(30) Foreign Application Priority Data
Jun. 19, 2000 (JP) 2000-183665

(51) Int. Cl. G06F 17/30

(52) U.S. Cl. 707/200; 707/102

(57) ABSTRACT

In a web site system including a center site and service sites accessible through the center site, a member information database is managed in the center site and stores member information of the service sites. The member information database stores the member information based on information concerning a member that is obtained at the center site or the service sites. And the center site sends the member information stored in the member information database to the service sites.

### BACKGROUND OF THE INVENTION

1. Field of the Invention

The present invention generally relates to Web site systems, center sites, service sites, and searching methods.

2. Description of the Related Art

With recent computer development, industries through networks have been rapidly developed. In such a circumstance, an effective suitable configuration is required for users, service sites and contents by the service sites.

Also, recently, it is becoming more important to manage individual information (region, hobby) of a user and to distribute more suitable information, so called “One to One marketing”.

Thus, each service site monitors not only information at a registration but also actions from the user after the registration, researches characteristics of the user, and then promotes products based on the characteristics of the user.

However, a management of the service site is closed therein. Information managed by the service site is not taken over to other service sites. The individual information of each user is separately collected and managed by each service site.

Thus, the user needs to register the individual information as a new user to another service site which the user wants to use. Such a registration transaction is a troublesome for the user.

In addition, in a certain service site, when a user purchased a product, information showing that the user purchased the product and how much the user paid for the product, does not report to another service site. Accordingly, when another service site promotes products, a product promotion is conducted without information concerning purchases of the user. Thus, the product promotion is not effectively conducted.

Also, there is another problem in that an accurate retrieval according to a user state is not always conducted.

### SUMMARY OF THE INVENTION

It is a general object of the present invention to provide a Web site system, a center site, a service site, and a searching method in which the above-mentioned problems are eliminated.

A more specific object of the present invention is to provide the Web site system, the Do center site, the service site, and the searching method, which can reduce overload related to a user registration from the service site, can obtain new member information from the service site, and can properly search for information corresponding to a state of the user.

The above objects of the present invention are achieved by a web site system including a center site (for example, a center site 10 in FIG.1) and a plurality of the service sites (for example, service sits 20₁ through 20_{N}) accessible through the center site; the web site system including: a member information database (for example, a member information database 13 in FIG.1) managed in the center site and storing member information of the plurality of the service sites, wherein: the member information database stores the member information based on information concerning a member that is obtained at the center site or the plurality of the service sites; and the center site sends the member information stored in the member information database to the plurality of the service sites.

According to the present invention, it is possible to reduce overload related to the user registration in each service site and it is also for each service site to obtain new member information.

### BRIEF DESCRIPTION OF THE DRAWINGS

Other objects, features and advantages of the present invention will become more apparent from the following detailed description when read in conjunction with the accompanying drawings, in which:

FIG.1 is a diagram showing a configuration of a Web site system according to the present invention;

FIG.2 is a diagram showing an example of region definitions according to the present invention;

FIG.3 is a block diagram showing a case in which a user makes an order of a pizza, according to the present invention;

FIG.4 is a flowchart for explaining a process in the example case, according to the present invention;

FIG.5 is a block diagram showing a case of updating a member information database in the center site according to the present invention;

FIG.6A is a flowchart for explaining a process when a pizza shop is selected in the case of FIG.5 according to the present invention and FIG.6B is a flowchart for explaining another process when a language school is selected in the case of FIG.5 according to the present invention;

FIG.7 is a diagram showing different search ranges of service types, according to the present invention;

FIG.8 is a diagram showing a service range defined by a house repair shop, according to the present invention;

FIG.9 is a diagram showing a structure of databases referred by several search methods according to the present invention; and

FIG.10 is a block diagram of a hardware configuration of the center site according to the present invention.

### DESCRIPTION OF THE PREFERRED EMBODIMENTS

An embodiment according to the present invention will be described with reference to figures. (Example of System Configuration)

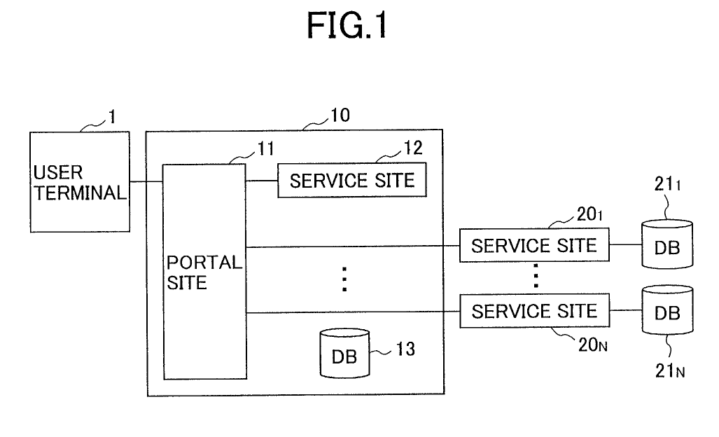

FIG.1 is a diagram showing a configuration of a Web site system according to the present invention.

The Web site system includes a user terminal 1, a center 10 and a plurality of service sites 20₁ through 20_{N}.

The user terminal 1, the center site 10 and the plurality of service sites 20₁ through 20_{N} are connected through a communication network such as Internet or the like.

The user terminal 1 can access a service site 12 and the service sites 20₁ through 20_{N} via a portal site 11.

The center site 10 includes the portal site 11, the service site 12 and a member information database 13. However, the service site 12 may not be required. For the sake of convenience, it will be described without the service site 12.

The Web site system according to the present invention is a system consisting of the center site 10 and the service sites 20₁ through 20_{N}.

Also, the service sites 20₁ through 20_{N} include databases 21₁ through 21_{N,} respectively, which are particular information used by the service sites 20₁ through 20_{N}.

Member Information Database

The member information database 13 stores member information including, for example, member name, member ID, address, telephone number, region, hobby, preferences, age, occupation, year salary and the like.

The member information database 13 stores member information of the service sites 20, through 20_{N}. Each of the service sites 20₁ through 20_{N} uses the member information stored in the member information database 13 through the center site 10.

The member information database 13 is a single database for the service sites 20, through 20,. A user registers as a member only for the center site 10 and then the user can access any of the service sites 20₁ through 20_{N} connected to the center site 10.

The member information database 13 creates and updates the member information based on information concerning the members that the center site 10 or the service site 20₁ through 20_{N} obtained.

Next, an example of storing “region” concerning the member information in the member information database 13 included in the center site 10 will now be described.

When “region” is registered, a plurality of places can be registered as a single region in the member information database 13.

In addition, in this case, an excluded place can be specified and then the single region can be registered with excluding the specified place.

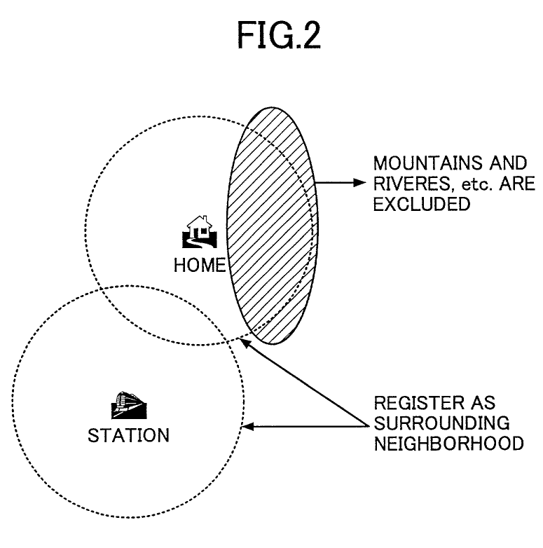

For example, as shown in FIG.2, when “surrounding neighborhood” is registered, a home address and a proximal station are registered. In this case, for example, the home address includes a 500 m circumstance and the proximal station includes a 500 m circumstance. Accordingly, when retrieval is conducted by using “surrounding neighborhood” as a key, the 500 m circumstance of the home address and the 500 m circumstance of the proximal station are retrieved as a range of the home.

Thus, the member information concerning “region” suitable to retrieve information, which is daily used, is registered.

Also, in this case, mountains and rivers can be excluded since they are not within a range of regions for daily activities.

Operation of System

The user terminal 1 accesses the service sites 20₁ through 20_{N} and then receives services from the service sites.

The user terminal 1 accesses the service sites 20₁ through 20_{N} through the portal site 11. In this case, the center site 10 retrieves the member information of the user from the member information database and then notifies the member information of one of the service sites 20₁ through 20_{N} that is indicated by a destination address of the user.

In addition, the center site 10 informs member ID information as a part of the member information if necessary. The service sites 20₁ through 20_{N} indicates the member ID information and queries the member information to the center site 10 by using the member ID information. In response to the query from the service sites 20₁ through 20_{N}, the center site 10 sends the member information stored in the member information database 13, to the service sites 20₁ through 20_{N}.

Also, when the user terminal 1 accesses the service sites 20₁ through 20_{N} the center site 10 classifies the member information of users and sends class information of the user as a part of or the entire member information to the service sites 201 through 20_{N}. For example, a region or a gender is sent as a class.

The service site, which receives the class information of the user, opens a home page suitable for the class. For example, the server site opens a home page related to a region of the user, for women or men, or the like.

In a case in which the user makes an action to the service sites 20₁ through 20_{N} (for example, the user uses one service site and then a service is provided to the user), the service sites 20₁ through 20_{N} sends a content of the action to the center site 10.

For example, when the user purchases a product, a product name, a price and the like are sent to the portal site 11. The center site 10 updates a purchase history of the user.

Also, the center site 10 additionally provides or modifies personal information based on purchase information. For example, in a case in which the user purchases a fashion product, information indicating that the user is interested in fashion products is additionally provided as characteristic information related to individual purchases.

By utilizing the characteristic information related to the individual purchases, a fashion product is promoted to users having the characteristics related to fashion and then the promotion can be effectively performed.

In addition, all information of actions conducted by each of the service sites 20₁ through 20_{N} are collected to the center site 10 and then a new database including new user information is generated. Each of the service sites 20₁ through 20_{N} can conduct promotions to users based on the new user information and can further effectively promote products.

Also, each of the service sites 20₁ through 20_{N} is not required to maintain the member information and just maintains a suitable promotion method that meets with each class of members or the like. Each of the service sites 20₁ through 20_{N} can dramatically reduce a process amount of managing the member information.

Service at Service site

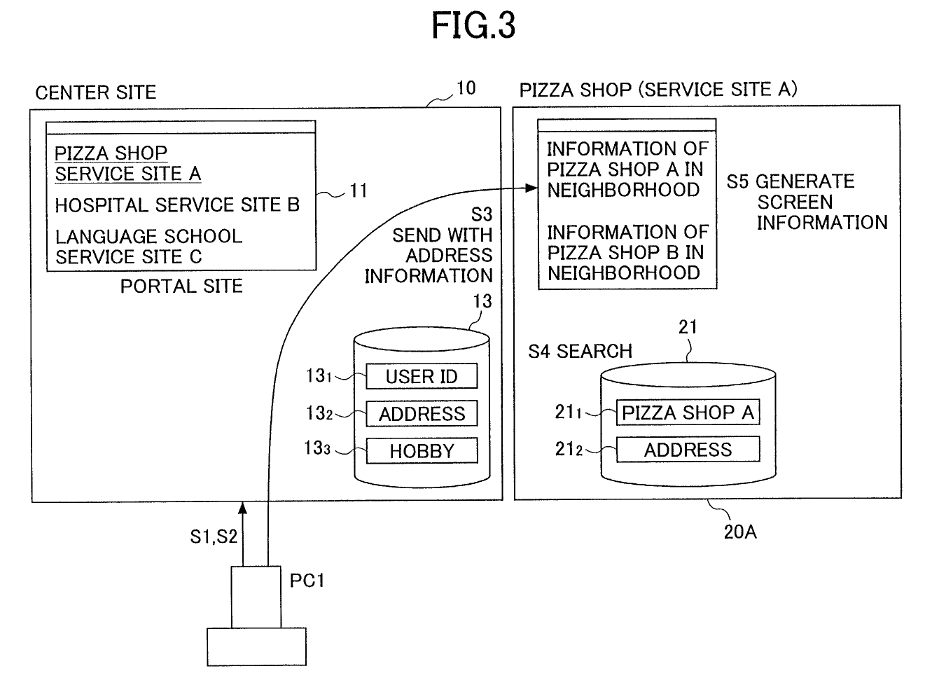

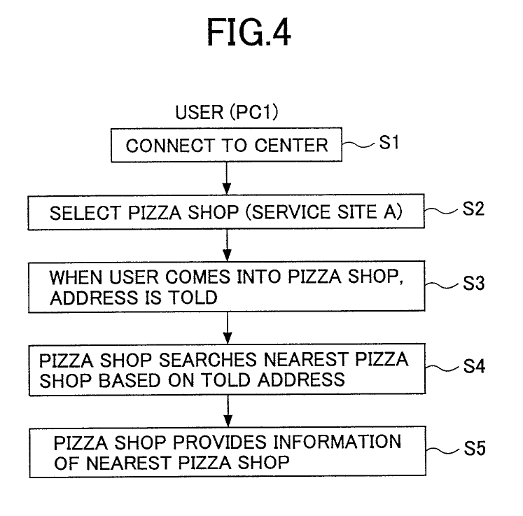

An example showing that the user makes an order of a pizza will now be described with reference to FIG.3 and FIG.4.

“Pizza Shop (Service Site A)”, “Hospital (Service Site B)”, “Language School (Service Site C)” and the like are displayed at a display of the portal site 11 at the center site 10.

Also, the center site 10 includes member information database 13 storing information including a user Id 13₁, an address 13₂, hobby 13₃ and the like for each user.

In addition, the service site A includes a database 21 concerning a pizza shop. In the database 21, information including a pizza hop name 21₁, an address 21₂ and the like is stored for each user.

Referring to FIG.3 and FIG.4, the user connects to the center site 10 by operation the user terminal 1 that is a personal computer (S1). For example, the user selects a pizza shop from a screen of the portal site 11 (S2). As a result, the portal site 11 connects to a service site A for the pizza shop selected by the user. In this case, the center site 10 searches for the member information database 13 and then sends an address of the user to the service site A (S3). The service site A searches for the address sent from the center site 10 from the database 21 and then automatically retrieves a pizza shop closer to the address of the user (S4). The service site A generates screen information including a retrieval result and then displays a screen based on the screen information (S5).

The user makes an order of a pizza directly from this screen.

Alternatively, the user may make an order of a pizza with reference to this screen by using another means (for example, telephone).

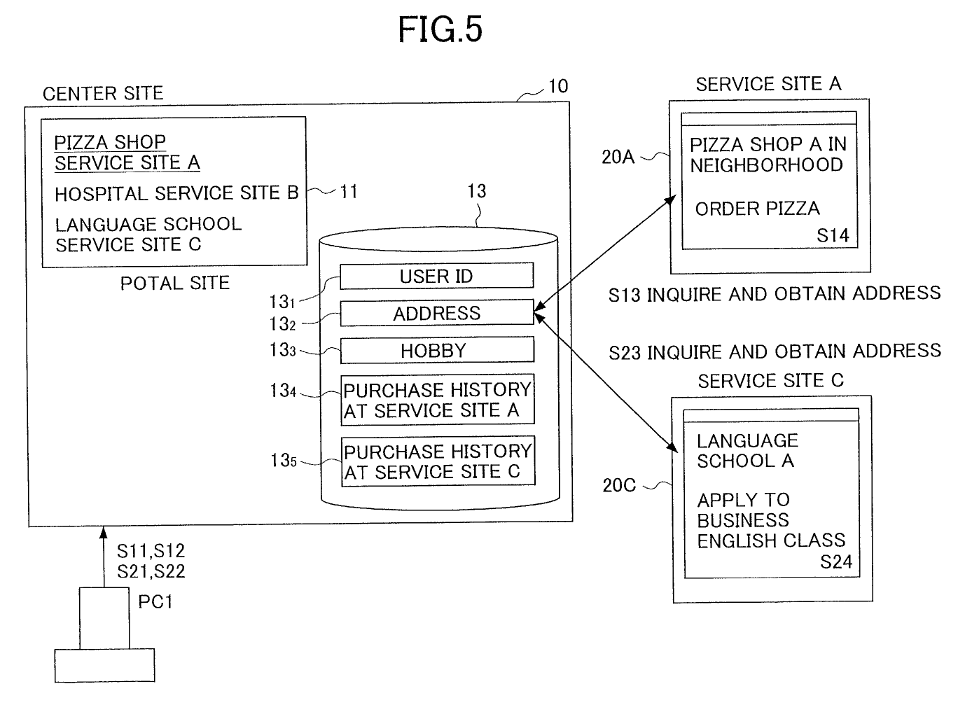

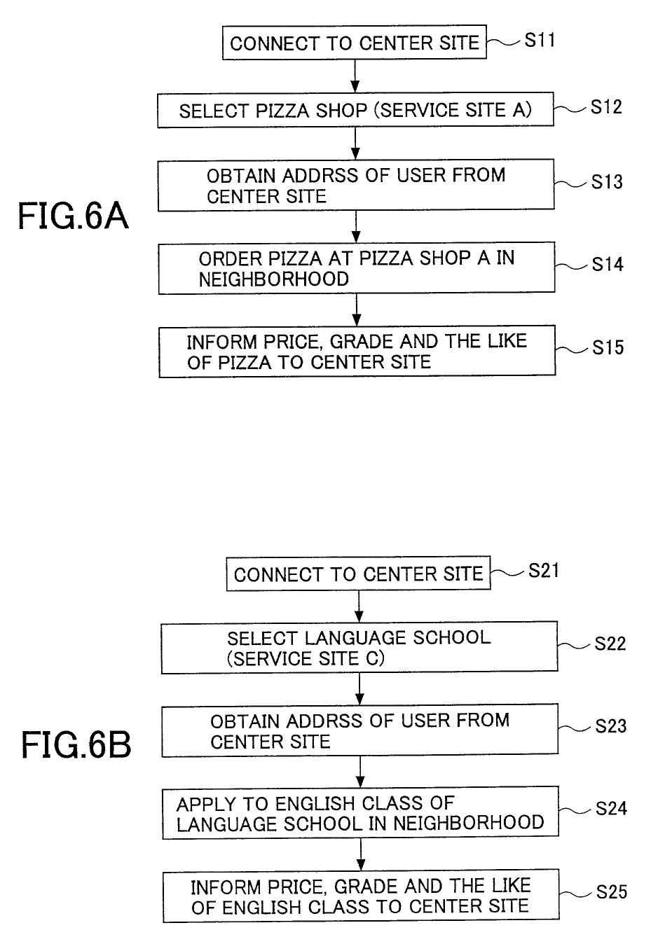

An example of updating the member information database of the center site will be now described with reference to FIG.5 and FIGS.6A and 6B.

Similarly to the example described in FIG.3, in FIG.5 and FIGS.6A and 6B, the user connects to the center site 10 (the portal site 11) by operating the user terminal 1 (S11). When the user selects a pizza shop from a screen displayed at portal site 11 (S12), the portal site 11 connects to the service site A. In FIG.5, the service site A inquires the member information database 13 by the user ID as a find key and obtains an address of the user (S13). The service site A searches for a closer pizza shop the database 21 based on the address obtained. The service site A generates screen information and displays a screen based on the screen information. The user refers to the screen and makes an order of a pizza (S14). The service site A informs a price, a grade and the like of the pizza to the portal site 11 in the center site 10 (S15). The center site 10 updates the member information database 13 based on the price, the grade and the like of the pizza informed from the service site A. For example, the center site 10 additionally provides new purchase information to the purchase history 134 for the user.

Subsequently, when the user applies to the language school, similarly, the member information database 13 of the center site 10 is updated and new purchase information is additionally provided to the purchase history 135.

As described above, the member information database 13 of the center site 10 is updated at each of actions conducted by the service sites 20₁ through 20_{N}.

That is, the same member information database 13 is updated by the actions of the service sites 20₁ through 20_{N}, which are separated and provide different services.

Search method

A search method conducted by each of a plurality of the service sites 12, 12₁ through 12_{N} (hereinafter representatively called the service sites 12), in a web site system including a center site 10 and the plurality of the service sites 12 accessible through the center site 10 will now be described.

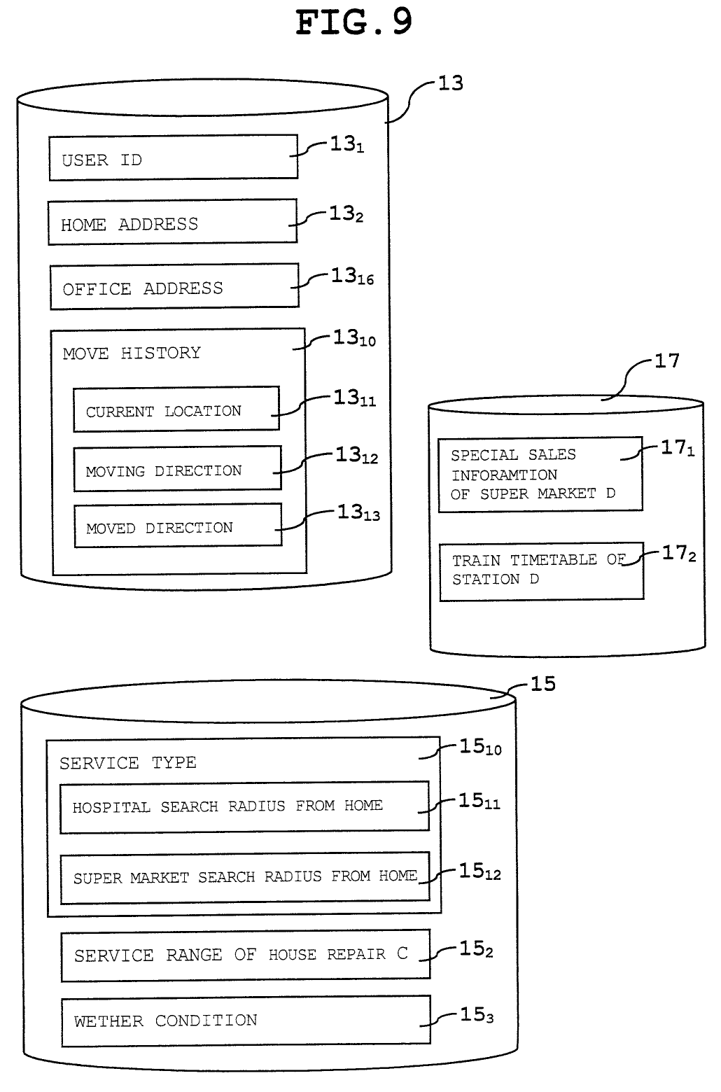

The service center 10 manages the member information database 11, a search condition database 15 and a special information database 17 as shown in FIG.9.

(1)First Search Method

For each service type, a range of providing information is defined. The service site 12 searches for information based on an address of a member (home address, office address or the like) and a selected service type, and then the service site 12 provides retrieved information to the member.

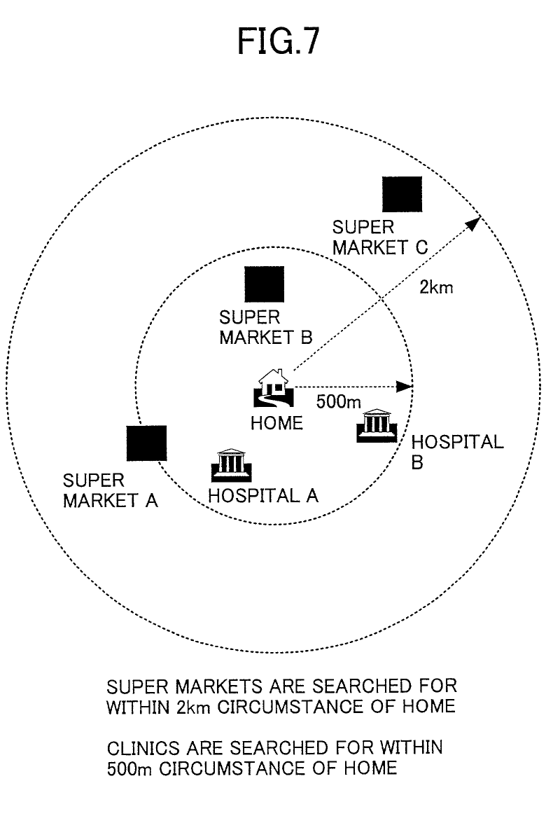

For example, as shown in FIG.7, in a case in which an institution is searched for, if the institution is a hospital, the service site 12 refers to a service type 15₁₀ of the search condition database 15 in the center site 10 in FIG.9 and searches for the institution within a 500 m radius indicated by a condition 15₁₁. If the institution is a super market, the service site 12 refers to the service type 15₁₀ of the search condition database 15 and searches for the institution within a 2 km radius indicated by a condition 15₁₂.

Hospitals matched with the condition 15₁₁ or super markets matched with another condition 15₁₂ are displayed at a user terminal.

By this method, proper information corresponding to the service type can be provided.

It should be that the above numbers of the conditions are examples and can be changed based on available transportations.

(2) Second Search Method

A service range is registered each time a service is provided to each of users. Also, a shop can register the service range in the search condition database 15 in the center site 10 in FIG.9. A search condition adding these service ranges is used to retrieve proper information. Thus, when the service range defined by the shop is not included in a searching range, information related to the shop is not retrieved.

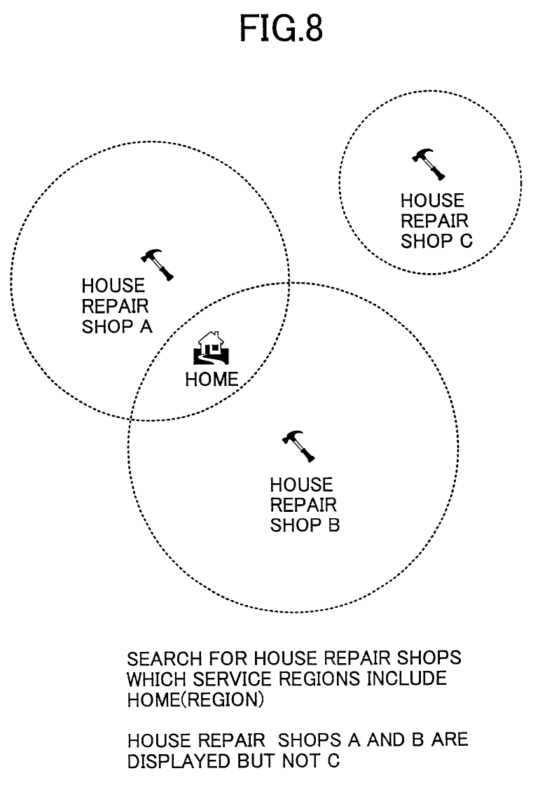

For example, as shown in FIG.8, when institutions are searched within a neighborhood of the home, house repair shops A, B and C are retrieved. However, the service range of the house repair shop C does not include the home since the house repair shop C registers the service range as a condition 15₂ of the search condition database 15. Accordingly, the house repairs A and B are displayed at the user terminal.

Hence, house repairs, which may reject a repair request from the user, are not displayed at the user terminal. Reliability of a search result can be improved.

(3) Third Search Method

Searching expressions are created based on specific institutions around a current location of the user. Accordingly, information suitable for the current location of the user can be provided.

For example, if the user is near a super market D, special sales information of the super market D is retrieved from the special information database 17, of which the super market registers the special sales information as special information 17₁, can be provided to the user. If the user is at a station D, timetable information of a train is retrieved from the special information database 17, of which the station D registers the timetable information as special information 17₂, can be provided to the user.

To find the current location of the user, PHS (Personal Handy-phone System) connected to the user terminal and GPS (Global Positioning System) can be utilized.

In order for the service site 12 to obtain the current location of the user, the user terminal may send information of the current location to the service site 12 arbitrary or periodically, or the service site 12 may send a polling signal to the user terminal to obtain the information of the current location. Then, the service site 12 stores obtained information related to the current location of the user as a current location 13₁₁, a moving direction 13₁₂ or a moved direction 13₁₃ in a move history 13₁₀, in the member information database 11.

(4) Fourth Search Method

In the third search method as described above, when the user moves at a constant speed, the search condition is changed and then information suitable for a state of the user can be provided to the user.

For example, when the user moves by a train, information related to super markets and stations along a moving direction is excluded.

Therefore, it is possible to prevent from displaying useless search results.

(5) Fifth Search Method

Based on the moving direction 13₁₂ of the move history 13₁₀ of the member information database 13, information suitable for the moving direction of the user can be provided by changing the search condition.

For example, when the user is moving toward an office of the user, information related to a destination (around the office) in the moving direction is provided.

When the user registers as a member, an office location may be included in register information of the user. The register information and the moving direction of the user are utilized to provide information suitable for the moving direction of the user.

(6) Sixth Search Method

Based on a moved distance 13₁₃ of the move history 13₁₀ of the member information database 13, information suitable for the moved distance of the user can be provided.

For example, when the moved distance of the user by a train is long, information including transfer stations can be provided.

(7) Seventh Search Method

Based on the move history 131, of the member information database 13, information suitable for the move history 13₁₀ of the user can be provided.

For example, when the current location 13₁₁ of the user is stable over night in weekdays, the current location 13₁₁ is recognized as a home location of the user. Then, daily life information can be provided.

Also, when the current location 13₁₁ is stable during daytime in weekdays, the current location 13₁₁ is recognized as an office location or a school location of the user. Then, information corresponding to the office location or the school location can be searched for and be provided to the user.

(8) Eighth Search Method

Based on a weather condition 15₃ (current weather condition or future weather condition) of the search condition database 15, information suitable for the weather condition 15₃ can be provided by changing the search condition.

For example, when the weather condition 15₃ shows a fine day, information available on foot can be displayed at the user terminal at a higher priority. When the weather condition 15₃ shows a rainy day, information available in a distance by a car, online hopping information and delivery service information can be displayed at the user terminal at a higher priority.

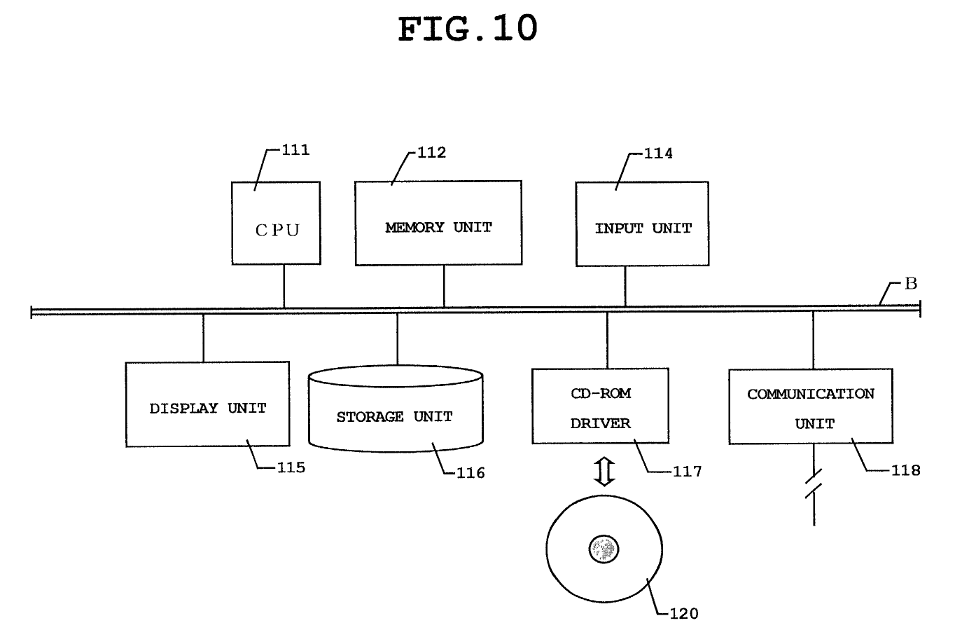

FIG.10 is a block diagram of a hardware configuration of the center site according to the present invention.

In FIG.10, the center site 10 as a computer system includes a CPU (Central Processing Unit) 111, a memory unit 112, an input unit 114, a display unit 115, a storage unit 116, a CD-ROM driver 117 and a communication unit 118, which are mutually connected by a bus B.

The CPU 111 controls the entire computer system in accordance with a program resident in the memory unit 112. In addition, the CPU 111 executes processes for providing information and centrally managing the member information sent from the plurality of the service sites 20 and 20₁ through 20_{N} that are described above. The memory unit 112 includes ROM and RAM. Also, the memory unit 112 temporarily stores programs and various data necessary for or obtained from executions of the processes. In addition, a part of the memory unit 112 is assigned as a working area accessed by CPU 111.

The input unit 114 includes a keyboard and a mouse but is not limited to only these input devices. The input unit 114 is used for a center manger to register and change information, and to input information into the computer system. The display unit 115 displays results of various processes or data necessary for the center manger.

The storage unit 116 includes a hard disk and stores various data and programs.

In accordance with instructions from the CPU 111, the CD-ROM driver 117 reads information from the CD-ROM 120 set in the CD-ROM driver 117 and then provides the information to the storage unit 116. For example, various programs according to the present invention are provided by the CD-ROM 120. That is, the programs read from the CD-ROM 120 are installed in the storage unit 116 through the CD-ROM driver 117. It should be noted that a recording medium is not limited to the CD-ROM 120, but another computer-readable recording medium such as a magnetic disk, a magnetic tape, an optical disk, a magneto-optical disk, a semiconductor memory or the like may be used.

According to the present invention, it is possible to reduce overload related to the user registration in each service site and it is also for each service site to obtain new member information.

In addition, the service site can rapidly conduct necessary processes based on the member information. If necessary, the service site can automatically conduct the searching process to retrieve proper information meeting to a requirement of the user.

Also, the service site displays a homepage suitable for the requirement of the user based on the class, at the user terminal.

Moreover, according to the present invention, it is possible to provide information suitable for a service type.

Furthermore, based on the service region registered for each shop, only shops available for a specific service can be retrieved. Therefore, it is possible to improve reliability of retrieved information as a search result.

In addition, it is possible to provide information corresponding to a specific institution around a current location of the user.

The present invention is not limited to the specifically disclosed embodiments, variations and modifications, and other variations and modifications may be made without departing from the scope of the present invention.

The present application is based on Japanese Priority Application No. 2000-183665 filed on Jun. 19, 2000, the entire contents of which are hereby incorporated by reference.

What is claimed is:

1. A web site system including a center site and a plurality of the service sites accessible through said center site; said web site system comprising:
a member information database managed in said center site and storing member information of said plurality of the service sites,
wherein:
said member information database stores the member information based on information concerning a member that is obtained at said center site or said plurality of the service sites; and
said center site sends the member information stored in said member information database to said plurality of said service sites.

2. The web site system as claimed in claim 1, wherein when a user accesses one service site of the service sites through said center site, said center site retrieves the member information of the user from said member information database and sends the member information to said one service site.

3. The web site system as claimed in claim 2, wherein said center site retrieves the member information of the user from said member information database, classifies the member information, and sends a class of the member information as a part of or an entire member information.

4. The web site system as claimed in claim 1, wherein said center site sends member ID information to one service site of the service sites, which the user accesses, and said one service site inquires the member information of the user to said center site by utilizing said member ID information and obtains the member information.

5. The web site system as claimed in claim 1, wherein when a user makes an action at one service site of said service sites, said one service site sends information concerning said action of the user to said center site.

6. The web site as claimed in claim 5, wherein said center site updates the member information of the user in said member information database by using said information concerning said action of the user.

7. A center site including a member information database storing member information, comprising:
a updating part updating said member information of said member information database in response to each action at service sites; and
a sending part the member information stored said member information database, when a user accesses one service site of said service sites or when any one of said service sites inquires the member information,
wherein each member information from said service sites connected to said center site is stored in said member information database and said member information database is a single database for said service sites.

8. A service site accessible through a center site including a member information database storing member information, said service site comprising:
an action information sending part sending information concerning an action of a user to update said member information database when the user makes an action at said service site,
so that said member information of said member information database in said center site is updated by and shared with other service sites accessible through said center site.

9. The service site as claimed in claim 8, further comprising a member information obtaining part obtaining the member information of a user from said center site when the user accesses said service site through said center site.

10. The service site as claimed in claim 8, wherein said member information obtaining part indicates information specifying the user as a member to said center site so as to obtain the member information of the user from said center site.

11. A method for searching information, said method conducted by one of service sites in a web site system including a center site and said service sites accessible through said center site, said method comprising the steps of providing information suitable for a service type by changing a search region for each service type.

12. A method for searching information, said method conducted by one of service sites in a web site system including a center site and said service sites accessible through said center site, said method comprising the steps of:
(a) registering a service region for each shop providing a service to an individual user; and
(b) searching for shops based on the service region in said step (a),
so that information related to one shop is not retrieved in said step (b) when the service region of the one shop, which service region is registered in said step (a), is out of a search region in said step (b).

13. A method for searching information, said method conducted by one of service sites in a web site system including a center site and said service sites accessible through said center site, said method comprising the steps of:
(a) creating a searching expression based on each specific institution around a current location of a user; and
(b) providing information corresponding to the specific institutions around a current location of a user based on the searching expressions defined in said step (a).

14. The method as claimed in claim 13, wherein said step (b) provides information suitable for a user state by changing a search condition based on a moving speed of the user.

15. A method for searching information, said method conducted by one of service sites in a web site system including a center site and said service sites accessible through said center site, said method comprising the steps of:
providing information suitable for a moving direction of a user by changing a search condition based on the moving direction.

16. A method for searching information, said method conducted by one of service sites in a web site system including a center site and said service sites accessible through said center site, said method comprising the steps of:
providing information suitable for a moved distance of a user by changing a search condition based on the moved distance.

17. A method for searching information, said method conducted by one of service sites in a web site system including a center site and said service sites accessible through said center site, said method comprising the steps of:
providing information suitable for a move history of a user by changing a search condition based on the move history.

18. A method for searching information, said method conducted by one of service sites in a web site system including a center site and said service sites accessible through said center site, said method comprising the steps of:
providing information suitable for a weather condition of a user by changing a search condition based on the weather condition.

19. A member information database included in a center site in a web site system including said center site and service sites accessible through said center site, said member information database comprising:
a defining part defining a plurality of places as a single region; and
a registering part registering said single region to said member information database.

20. The member information database as claimed in claim 20, further comprising an excluding part specifying places to be excluded and excluding said places from said single region registered by said registering part.
